(19) United States
(12) Patent Application Publication
(10) Pub. No.: US 2005/0131894 A1
(43) Pub. Date: Jun. 16, 2005

(54) System and method for providing identification and search information

(76) Inventor: Chau Minh Vuong, Garden Grove, CA (US)

Correspondence Address: CROWELL & MORING LLP;INTELLECTUAL PROPERTY GROUP, P.O. BOX 14300, WASHINGTON, DC, 20044-4300, US

(21) Appl. No.: 11/008,907

(22) Filed: Dec. 10, 2004

Related U.S. Application Data
(60) Provisional application No. 60/528,984, filed on Dec. 11, 2003.

(51) Int. Cl. G06F 17/30

(52) U.S. Cl. 707/5

(57) ABSTRACT

A system and method for identifying an entity. In one embodiment, the system and process defines the person by assigning a distinct code for each person's information such as demographic information, personal information and traits. The identification information may be incorporated into one or more web pages associates with the person to facilitate searching by others using an Internet search engine, or grid computing application, a peer-to-peer/file-sharing network.

### CROSS-REFERENCE TO RELATED APPLICATION

This application is related to and claims priority from U.S. provisional patent application Ser. No. 60/528,984, filed on Dec. 11, 2003.

### BACKGROUND OF THE INVENTION

1. Field of the Invention

The invention relates in general to criteria-based searching, and in particular to systems and methods for providing identification and search information in an online context.

2. Background of the Invention

The current model for electronic searching requires the use of flat files or database servers, such as Oracle, mySQL, or Microsoft SQL Server/Access. These database servers are used to retrieve data based on a user's criteria usually in a form of a query statement (eg. SELECT*FROM table_name WHERE field_one>100). Database servers can be clustered together to increase their database size and to handle more users.

For complex searches that require extensive computation power, the data is broken down into smaller pieces and assigned to various computers to search in parallel. This technology is referred to as grid computing, using geographically distributed computers, unified to create a supercomputer for solving data intensive computing applications. Currently, grid computing is used to search for extraterrestrial intelligence (SETI@home), to find the drug candidates to cure diseases, and to forecast the weather.

For larger databases with millions of users, such as an Internet search engine's index, data is distributed across a network of computers. To prevent over-utilization of computer resources, search engines are limited to search for keywords and are unable to search for complex entities. In computer science, complex entities are often referred to as objects. An object is a grouping of related characteristics that represents a real world thing. For example, the object for people have multiple traits and properties such as height, eye color, ethnicity, and interest. In other words, search engines, while great at searching for keywords in web documents, are poorly suited to search for pictures, people, and audio-video files using ranges of criteria.

In computer science, an identification system, usually called metadata, is often used to manage data. Metadata is data that describes data, helps identify, organize, and retrieve complex objects. Often this metadata is included, associated, or attached to the object itself and becomes a meta tag. Examples of offline versions of meta tags are UPC/bar codes that manufacturers use to identify their products, book call numbers used by libraries to identify books, and DNA sequences that encode people.

Currently, online searches by a large user base for complex objects using multiple search criteria require many enterprise database servers. Such complex queries are extremely server intensive requiring major infrastructure expenditure to support a large user base.

In the case of searching for people, most online communities (e.g., chat rooms, instant messaging, message boards, etc.) avoid this cost by providing directories of web/blog rings and interest groups that members join. Free social networking communities offer simple searches limited to a few criteria. For communities that offer complex searches, such as online dating services, most must charge membership fees to cover this cost.

Internet search engines, having the infrastructure to handle millions of daily queries, are unable to search for people and other complex objects because they were designed to only search for keywords, and not for multiple criteria or ranges of criteria. Examples of some of these criteria are location, size, shape, age, and color.

Grid computing could be used for complex searches, eliminating the use and cost of database servers. The data could be segmented into smaller files and distributed to many computers, each assigned to search through a particular file. However, the disadvantages of using grid computing are many, especially if the objects are large or complex. If the metadata system is not efficient, the file or data stream that contains the metadata will be large, consuming enormous amount of bandwidth, increasing download time, increasing hard drive and memory storage requirements, and increasing the amount of time to search through the metadata. Thus, there is a need for an improved system and method for a systematic, reliable approach for providing identification and searching functionality for complex objects.

### BRIEF SUMMARY OF THE INVENTION

Systems and methods for providing identification and search information are disclosed. In one embodiment, a method includes receiving identification information representative of a plurality of characteristics of an entity, representing said identification information with an identification code, wherein the identification code is comprised of a plurality of tags, and incorporating the identification code into a digital file associated with the entity, wherein the digital file can be located using a search code containing at least a portion of the identification code.

Other aspects, features, and techniques of the invention will be apparent to one skilled in the relevant art in view of the following detailed description of the invention.

### BRIEF DESCRIPTION OF THE DRAWINGS

FIG. 1A is a system block diagram of one embodiment of a network system in which one or more aspects of the invention may be implemented;

FIG. 1B is a system block diagram of another embodiment of a network system in which one or more aspects of the invention may be implemented;

FIG. 2 is a system block diagram of one embodiment of a computer system in which one or more aspects of the invention may be implemented;

FIGS. 3A-3E illustrate embodiments of graphical user interfaces for entering a user's identification information;

FIGS. 4A-4B illustrate embodiments of presentation screens for displaying the information entered by the user using the interfaces of FIGS. 3A-3E;

FIGS. 5A-5C illustrate one embodiment of the identification code corresponding to the information entered by a user, for example, using the interfaces of FIGS. 3A-3E;

FIGS. 6A-6C illustrate one embodiment of the user interface used to enter a search criteria;

FIG. 7 illustrates one embodiment of a user's search criteria entered using interfaces of FIGS. 6A-6C, translated into search code to be used in an Internet search engine;

FIG. 8 illustrates one embodiment of a user's search code being used in an Internet search engine along with the search result;

FIG. 9 illustrates one embodiment of an application module translating identification information into identification code in HTML;

FIGS. 10A-10B illustrate one embodiment of a web journal (blog) tagged with identification code in accordance with the principles of the invention;

FIG. 11 illustrates one embodiment of a grid search application's graphic interface that may be implemented in accordance with the invention;

FIG. 12 illustrates one embodiment of an interface for initiating contact with a member;

FIG. 13 illustrates one embodiment of an interface for implementing contact criteria to be used in a contact filtering or compatibility matching service; and

FIG. 14 illustrates one embodiment of an interface for implementing a privacy access filter, consistent with the principles of the invention.

### DETAILED DESCRIPTION OF EXEMPLARY EMBODIMENTS

One aspect of the invention is to provide a system and method for identifying an entity. In one embodiment, the system and process defines a person by assigning a distinct code for each person's information such as demographics, physical attributes, and personality traits. The identification code may be incorporated into one or more web pages associated with the person to facilitate searching by others using an Internet search engine. The identification code may be aggregated with other identification codes of other members into an index (e.g., a digital file) to be used in grid computing. This system and method may be used to search and locate people for personal, employment, sales, mentoring, investing or other purposes. While in one embodiment the entity is a person, it should equally be appreciated that the entity may be anything which is identifiable by one or more characteristics.

A second aspect of the invention is to provide a system and method for representing the identification information as an identification code. In one embodiment, the identification code can be provided by the user to identify himself/herself and to facilitate searching by others. In another embodiment, the identification codes for a plurality of entities may be indexed to form a searchable entity index.

A third aspect of the invention is to provide a system and method for locating a desired entity. Once an individual provides search criteria, it may be compiled into a search code which is used by a search engine to locate matching identification codes on web pages or by a grid application to search an entity index.

A fourth aspect of the invention is to provide a system and method for representing the search criteria as a search code. In one embodiment, this search code may then be used by a search engine or grid application.

As discussed herein, a “computer system” is a product including circuitry capable of processing data. The computer system may include, but is not limited to, general purpose computer systems (e.g., server, laptop, desktop, palmtop, personal electronic devices, etc.), personal computers (PCs), hard copy equipment (e.g., printer, plotter, fax machine, etc.), banking equipment (e.g., an automated teller machine), and the like. Content and/or media elements refers to application programs, driver programs, utility programs, file, payload, and combinations thereof, as well as graphics, informational material (articles, stock quotes, etc.) and the like, either singly or in any combination. A “communication link” refers to the medium or channel of communication. The communication link may include, but is not limited to, a telephone line, a modem connection, an Internet connection, an Integrated Services Digital Network (“ISDN”) connection, an Asynchronous Transfer Mode (ATM) connection, a frame relay connection, an Ethernet connection, a coaxial connection, a fiber optic connection, satellite connections (e.g. Digital Satellite Services, etc.), wireless connections, radio frequency (RF) links, electromagnetic links, two way paging connections, etc., and combinations thereof.

System Overview

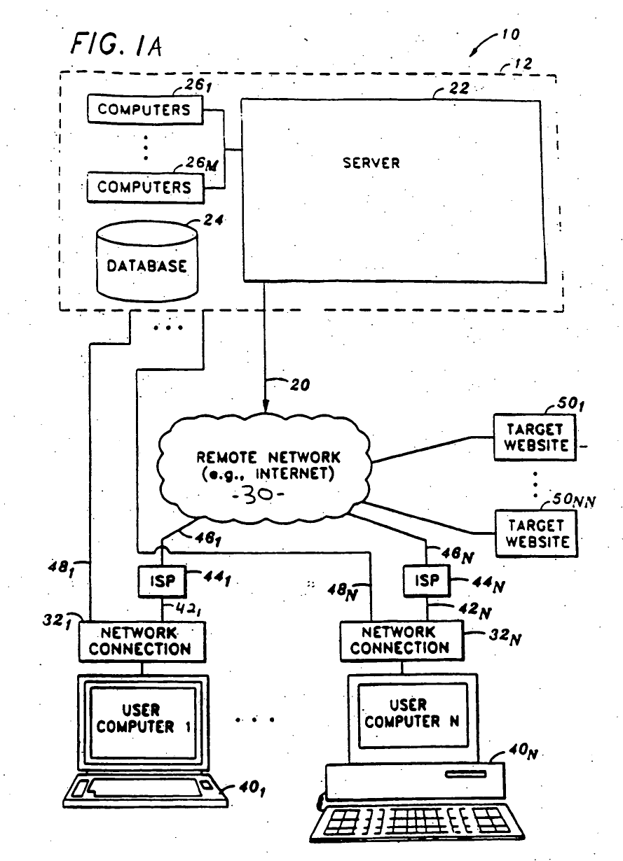

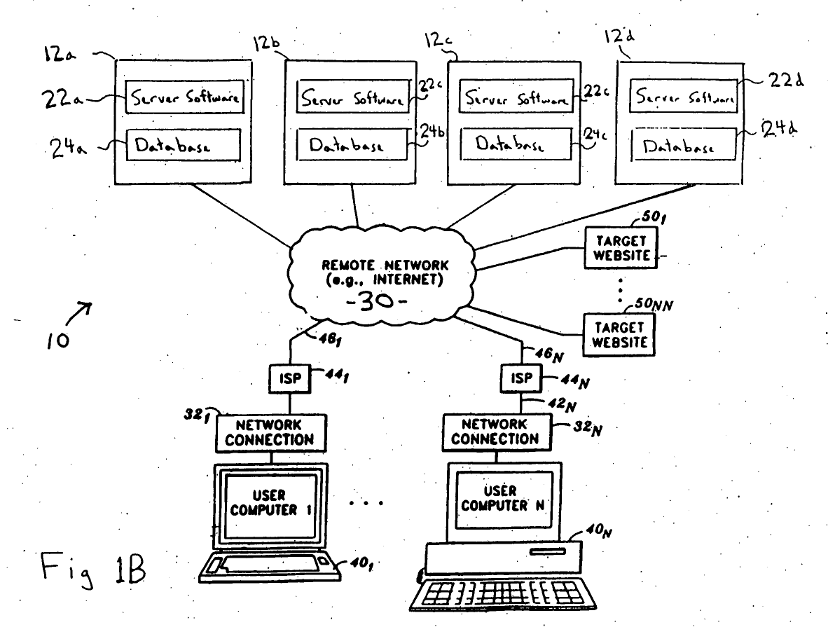

A description of an exemplary system, which incorporates embodiments of the invention, is herein described. FIG. 1A shows a system block diagram of one embodiment of a network system 10 in which the system and method of the invention is used. Referring to FIG. 1A, the network system 10 comprises a service center 12 that is connected over one or more communication links 20 to a remote network 30 (e.g., a wide area network or the Internet) or a remote site (e.g., a satellite, which is not shown in FIG. 1A) to one or more user computer systems 40₁-40_{N} (“40”). In one embodiment, the service center 12 is a website. The service center 12 includes one or more servers 22 and one or more databases 24. In one embodiment, the server 22 includes software modules that may be downloaded for performing the processes of the invention, as described in detail in the following sections.

The service center 12 may also include one or more computers 26₁-26_{M}. If a plurality of computers are used, then the computers 26₁-26_{M} may be connected by a local area network (LAN) or any other similar connection technology. However, it is also possible for the service center 12 to have other configurations. For example, a smaller number of larger computers (i.e. a few mainframe, mini, etc. computers) with a number of internal programs or processes running on the larger computers capable of establishing communication links to the user computers.

The remote network 30 or remote site allows the service center 12 to provide peer-to-peer information and services to the user computers 40₁-40_{N}, using software that is stored at the service center 12. In one embodiment, the user computers 40 may be any computer system or any other device that processes and/or presents audio and/or video information. The one or more databases 24 connected to the service center computer(s), e.g., computer 26₁, are used to store data. Each user computer 40 is connected via network connection 32₁-32_{N} over a corresponding communication link 42₁-42_{N} such as a local carrier exchange to a respective ISP 44₁-44_{N}, through which access to the remote network 30 is made.

By inputting the URL address of the target website with which the user desires to interact, the user may be connected to various target websites, such as websites 50₁-50_{NN}. In an alternate embodiment, each user computer 40 may be connected via network connection 32₁-32_{N} over a corresponding communication link 48₁-48_{N} to the service center 12, which provides internet access and service to the user computer(s) 40.

One aspect of the present invention relates to developing identification codes usable to search for entities having particular characteristics. The software for providing such processes may be developed and/or stored on a computer 40, or may be developed using one of the computers 26₁-26_{M}. Upon completion of the development process, the software may be stored in the computer 40 or in the database 24. Alternatively, the software may be stored on a machine-readable medium, in any of the computers 40 or computers 26₁-26_{M}.

FIG. 1B depicts another embodiment of the network system 10 of FIG. 1A. Rather than the single server structure of FIG. 1A, the network system 10 of FIG. 1B has user computers 40 connected to and in communication with a plurality of service centers 12a-12d. In this embodiment, each of service centers 12a-12d includes servers 22a-22d and databases 24a-24d. While FIG. 1B is shown with four service centers 12a-12d, it should be appreciated that more or fewer service centers may also be used in network system 10.

As will be discussed in more details below, content may be streamed from one or more of service centers 12a-12d to user computers 40. In one embodiment, one or more of service centers 12a-12d stream individual segments of media content for caching at ISPs 44₁-44_{N} (“44”). ISPs 44 may then provide the cached media content to user computers 40 as requested.

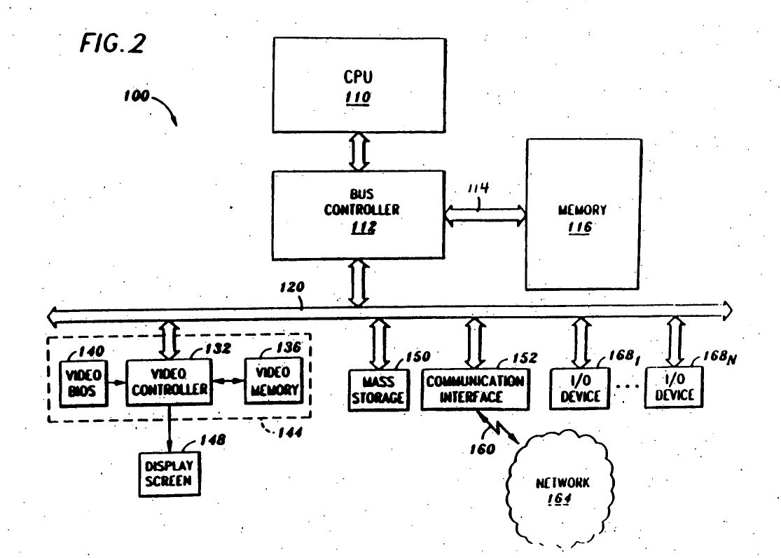

Referring now to FIG. 2, the computer system 100 (representing either of computer 26 or 40) comprises a processor or a central processing unit (CPU) 110. The illustrated CPU 110 includes an Arithmetic Logic Unit (ALU) for performing computations, a collection of registers for temporary storage of data and instructions, and a control unit for controlling operation for the system 100. In one embodiment, the CPU 110 includes any one of the x86, Pentium™, Pentium II™, and Pentium Pro™ microprocessors as marketed by Intel™ Corporation, the K-6 microprocessor as marketed by AMD™, or the 6x86MX microprocessor as marketed by Cyrix™ Corp. Further examples include the Alpha™ processor as marketed by Digital Equipment Corporation™, the 680x0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 110. The CPU 110 is not limited to microprocessor but may take on other forms such as microcontrollers, digital signal processors, reduced instruction set computers (RISC), application specific integrated circuits, and the like. Although shown with one CPU 110, computer system 100 may alternatively include multiple processing units.

The CPU 110 is coupled to a bus controller 112. The bus controller 112 may include a memory controller (not shown) integrated therein, though the memory controller may be external to the bus controller 112. The memory controller provides an interface for access by the CPU 110 or other devices to memory 116 via memory bus 114. In one embodiment, the system memory 116 includes synchronous dynamic random access memory (SDRAM). System memory 116 may optionally include any additional or alternative high speed memory device or memory circuitry. The bus controller 112 is coupled to a system bus 120 that may be a peripheral component interconnect (PCI) bus, Industry Standard Architecture (ISA) bus, etc. Coupled to the system bus 120 are a graphics controller, a graphics engine or a video controller 132, a mass storage device 150, a communication interface device 152, and one or more input/output (I/O) devices 1681-168N. The video controller 132 is coupled to a video memory 136 (e.g., 8 Megabytes) and video BIOS 140, all of which may be integrated onto a single card or device, as designated by numeral 144. The video memory 136 is used to contain display data for displaying information on the display screen 148, and the video BIOS 140 includes code and video services for controlling the video controller 132. In another embodiment, the video controller 132 is coupled to the CPU 110 through an Advanced Graphics Port (AGP) bus.

The mass storage device 150 includes (but is not limited to) a hard disc, floppy disc, CDRW-ROM, DVDRW-ROM, tape, high density floppy, high capacity removable media, low capacity removable media, solid state memory device, etc., and combinations thereof. The mass storage device 150 may include any other mass storage medium. The communication interface device 156 includes a network card, a modem interface, etc. for accessing network 164 via communications link 160. The I/O devices 168₁-168_{N} include a keyboard, mouse, audio/sound card, printer, and the like. The I/O devices 168₁-168_{N} may be disk drive, such as a compact disc (CD) drive, a hard disc drive, a tape drive, a zip drive, a jazz drive, a digital versatile disc (DVD) drive, a magneto-optical disk drive, a high density floppy drive, a high capacity removable media drive, a low capacity media device, and/or any combination thereof.

The information, content and/or application software may be stored in the database 24, on the computers 40, or on a machine-readable medium. The information, content and/or application software may also be made available to users such as those located at user computer 1-N, i.e., computers 40₁-40_{N}, through service center 12 or by means of the machine-readable medium.

In accordance with the practices of persons skilled in the art of computer programming, the invention is described below with reference to symbolic representations of operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data its at memory locations such as in system memory, as well as other processing of signals. The memory locations where data its are maintained are physical locations that have particular electrical, magnetic, optical, or organic properties corresponding to the data bits. Thus, the term “server” is understood to include any electronic device that contains a processor, such as a central processing unit.

The Members

In one embodiment, where the entity that is being identified and searched is a person, the term “member” may be used to refer to anyone who has a web page that is crawled by an Internet-based search engine or can otherwise be accessed by the Internet, as well as anyone who is a member of a dedicated site. Examples of possible members include AOL members; numerous Internet service providers that offer free home pages; members of organizations such as Blogger, GeoCities, Tripod, etc.; college student home pages; social networking communities such as Friendster, association or club websites, and web address registry services which may offer a web pages for free. In addition, members of a dedicated site who do not have access to web hosting are often offered free personal pages.

Other examples of virtual communities that are able to use this identification and search system include but not limited to voice-over-IP telephony, instant messengers, blogging communities, home page or personal page sites, and cellular phone users.

Identification System

One aspect of the invention is to provide a standard system for identifying and describing entities, such as people. Such a system may enable an efficient search for the entity over a global networking system, such as the Internet, a grid computing network, a peer-to-peer network, or a wireless network. The identification system and process may be used to provide a systematic approach to identifying all entities. This coding system will be referred to herein as the SocialGrid identification system. While the following sections refer to the SocialGrid search engines, servers, grid searches, etc., it should be appreciated that this is only a naming convention and not a limitation. For discussion purposes only, the following sections will discuss the entities of interest as being people.

In one embodiment, a series of codes may be used to represent a person's profile. This identification code may then be placed onto a person's web page for search engines to index, allowing for anyone to search for that person. A compacted version of this identification code may be included into an index—a digital file. A grid application may then be used to search this index to allow members to search using more complex search criteria than would otherwise be possible. In another embodiment, the indexing process may be carried out using an Internet-based search application which harvests and/or search the identification codes for a plurality of entities. In one embodiment, such an Internet-based search application includes Internet spiders and crawlers.

Location of the Identification System

For purposes of discussion, the system for identifying may be located on a predetermined location or site. Such a location or site may be a personal computer or electronic device of a member or an affiliate or partner of a dedicated server or computer. In one embodiment, the system for identifying may be a software application located on a desktop computer, a cell phone, or any other electronic device. In another embodiment, it could be a web-based application located on a web server.

Obtaining Identification Codes

In one embodiment, identification codes may be obtained by hand coding using predetermined guidelines (e.g., guidelines published on a SocialGrid web site). In another embodiment, individuals may enter their profile to generate their identification code using a web application or a software application residing on a desktop computer or any other electronic device such as a mobile phone. In one embodiment, individuals may also use a web-based or software application to generate profile HTML pages tagged with the identification code that can be downloaded and used on the individuals own website, or alternatively, published onto a web site.

Location of Identification Code

In one embodiment, the identification code may be placed on a web page, such as encoded in HTML or other computer programming and scripting languages that are able to generate web pages (JavaScript, VBScript, PHP, ASP, JPS, Flash, PDF, XML, RDF, etc.). The identification code can either be visible (allowing it to be viewed by a web browser) or hidden. The identification code can be hidden when it is included in a section of the web page code that is not normally displayed by a web browser, such as in the META, ALT and TITLE tags. The identification code can also be placed in a web page that contains a hyperlink to the member's profile or image. In other words, the identification code can be independent of other web pages containing more detailed information of the member or entity. Also, digitized, encrypted or binary forms of the identification code can reside in other digital files, memory of electronic devices or digital streams in cyberspace and wireless networks. Additional embodiments may include placing the identification codes on people, physical locations, products, and other entities.

Identification Code for Search Engines that Index Pictures and Images

To facilitate inclusion in picture or image search engines, such as Google™ Image Search, the identification code could be hyperlinked to a picture of the member. It also could be placed in close proximity to the picture to increase the probability of image search engine inclusion.

Search System

In one embodiment, there may be two ways to search for members. The first one is using Internet search engines, such as Google™, to conduct the search. To create a search criteria, a member may use an input form to select what demographics and traits of the person they are searching for. The search criteria is transformed into a search code that can be used in an Internet search engine. If the search code matches the tags or sequence of tags of the identification code, a match is made.

The second way to search for members is to use a grid search application, which in one embodiment may be implemented using a grid or P2P (peer-to-peer) application. If the search criteria matches the identification code that has been stored or gathered in an index (which in one embodiment is a digital file containing all member's identification code) a match is made.

Location of the Search System

For purposes of discussion, the system for search may be located on a predetermined location or site. Such a location or site may be a personal computer or electronic device of a member or an affiliate or partner of a dedicated server or computer. In one embodiment, the system for searching may be a software application located on a desktop computer, a cell phone, personal digital assistant or any other electronic device. In another embodiment, it could be a web-based application located on a web server.

Obtaining Search Codes

In one embodiment, search codes may be obtained by hand coding using predetermined guidelines (e.g., guidelines published on a SocialGrid web site). In another embodiment, individuals may enter their search criteria into an user interface of a web application to select what demographics and traits of the person they are searching for. The user interface could also belong to a software application residing on a desktop computer or any other electronic device, such as a cellular telephone, PDA, etc.

Search codes may be generated using the same coding system that generates identification codes, except search codes only include codes related to the search criteria. In one embodiment, the application will generate the combination of tags and sequence that will use the least amount of keywords in a search engine. In another embodiment, when search codes are used in search engines, sequences may be enclosed in quotes and plus signs are added in front of tags and sequences. Search code to be used by a grid application may not have these additional characters.

Location of Search Code

Search codes can be stored as a digital file or in a database record in various locations. Such a location or site may be a personal computer or electronic device of a member or an affiliate or partner of a dedicated server or computer. In one embodiment, search codes can be located on a remote server (e.g., SocialGrid's servers). Moreover, search code can be stored or reside on any electronic device.

Search Using Search Criteria

Search criteria, alone, can be used to search for identification codes. Search criteria could be represented with variables of a computer programming language. A software application using conditionals. Conditionals, using variables along with comparative and logical operators of a computer programming language, could determine a match. A match is made if at least a portion of the identification code matches the conditionals.

Search Method

Internet Search Engine

For simple searches, one may leverage the major Internet search engines, such as Google™. Because of various Internet search engine's ability to search billions of pages efficiently, a system of tagging web pages using a series of codes to represent a person's demographic information and traits may be used, allowing anyone with access to the Internet search engine to search for people using this coding system. If the search code entered in or sent to a search engine matches the tag(s) or sequence of tags of the identification code that resides on a webpage, a match is made.

As is known, Internet search engines represent a fast way to search billions of web pages. In addition, certain Internet search engines rank web pages higher if they have other websites linking to them. The result is that spam pages, which nobody will link to, are ranked lower than legitimate web pages. Internet search engines are also free and highly accessible to everyone, and can even be used by mobile phones and PDAs that have access to the Internet.

However, Internet search engines also suffer from a number of limitations. Perhaps the biggest limitation is that searches are typically limited to 10 search criteria (keywords). In addition, indexing is only updated every month and there is no guarantee of inclusion into the index. Also, Internet search engines are unable to search for ranges because they were designed to search for specific keywords. One aspect of the invention is to address these short comings as described in detailed below.

Grid Search Method

In one embodiment, an index, digital file of all members' identification codes, may be compiled, compressed, and distributed on regular time intervals (e.g., real-time, daily, weekly, monthly) from, for example, SocialGrid's servers, its partners' servers, members' own personal computers, or a peer-to-peer/file sharing network. A client, a software application that resides on a remote computer or electronic device, may be used to search the index. Members using the client can download and expand the index onto their computer to perform their search. In another embodiment, the index could be constructed by crawling a digital or wireless network or streamed to the user in real time using a distributed network such as a peer-to-peer/file-sharing network, wireless network, or a dedicated server.

In one embodiment, the client can either download search codes or search criteria of members from a remote server or use a local copies residing on a computer or other electronic device to perform this search of the index. In another embodiment, search criteria recently inputted into a user interface, stored in a database, or yet to be compiled to search codes, could be used. The client may use both search criteria and search codes to determine matches with identification codes in the index. If the search code or search criterion matches the identification code that has been stored or gathered in an index (which in one embodiment is a digital file containing all member's identification code), a match is made.

Unlike Internet search engines, in one embodiment there is no limitation on the number of search criteria that may be used with the grid search (e.g., SocialGrid grid search). In addition, the grid search may permit Boolean searches. Moreover, the index can be updated instantaneously, every day, or every week.

Because the identification system uses codes and not keywords, the use of it in grid computing is made feasible because the distributed files may be much smaller resulting in less bandwidth, download time, hard drive storage, memory usage, and search time. In addition, to minimize download and search time of the index, the index can be fragmented into different versions using the different categories. For example, the index can be divided by gender (example: a male and female indexes), age range (example: 20-30, 40-50), or location (example: only in California). Each index version may vary in file size.

Based on a member's search criteria or search code, remote servers (e.g., SocialGrid's servers) or a client application (e.g., those belonging to SocialGrid's, it partners, or member) may determine what is the smallest index to download. This decision may be based using an algorithm that parses the members search criteria or search code, makes a list of possible indexes available, and ranks the indexes by size or date. Existing indexes that have been downloaded in the past may also be used to determine which index version needs to be downloaded or updated. In another embodiment, no index will need to be downloaded because the index version on the member's computer may already be the latest or smallest version.

In one embodiment, members first log in to a dedicated site (e.g., the SocialGrid website) directly or through a client application. A remote server (e.g., SocialGrid servers) or client then determines if there is an existing index or if the index needs to be updated by comparing the current index on the client's computer and what the latest indexes are. If an index needs to be downloaded, then it may be downloaded to the member's computer and expanded. Depending on the user's preference, the index can be searched as it is downloading (as a digital stream) or searched as a downloaded file.

As the client compares the identification codes against search criteria or search code, those profiles that match may be displayed in the search result text box. Each result may also be assigned its respective web address, which in one embodiment is the web address location of that member's profile. This web address could either be included in the index or found and downloaded using remote database servers using a unique identification number of each matched profiles. In one embodiment, clicking the result will open a web browser that will be re-directed to that web address. Images of the member and other profile information may be displayed in the application to represent the matching search results.

Identification and Search Coding System

In one embodiment, the identification coding system uses 2 to 4 letters to represent each demographic information or trait category. This part is referred to as the tag prefix. However, it should equally be appreciated that more or fewer letters, symbols, numerals or any combination thereof may be similarly used. Following these letters are numbers describing each demographic information or trait. A combination of the letters and numbers is called a tag. Tags arranged in a specific sequence to represent the entity's characteristics may be referred to as an identification code. Tags arranged in a specific sequence to represent a search criterion, the characteristics of a desired entity, is referred to as search code.

In one embodiment, an identification or a search code may be created using of 5 types of tags. A tag that represents a characteristic of a entity is called a profile tag. For example, to create a tag for gender, the tag prefix “GD” can be attached to a number (1=male, 2=female, etc . . . ). Therefore, the tag for male is “GD1”. Other types could also be used such as combination tag, range tag, “looking for” profile tag, “looking for” combination tag, and “looking for” range tag. The definition of these types of tags will be explained below.

Search by Sequence to Bypass Keyword Limits of Internet Search Engines

In one embodiment, the sequence of these tags is important to maximize the number of search criteria that are used in the search engines. Because search engines limit the number of criteria, searching for sequences of tags allows users to search for more criteria than normally allowed by the search engines. For example, searching for four criteria in Google™ using the traditional search format, a user may enter the following search code into the Google™ textbox: +AG32+GD1+GP2+MS1. As will be described below in more detail, these four tags of the search code relate to the individual's age, gender, gender preference and marital status. However, since Google™ only allows a limit of 10 criteria, this simple search has already used up 4 out of the 10 available search criteria.

In contrast, because tags consistent with the invention are arranged in a specific sequence, a user would only need to use one criterion to search for the four criteria above. In particular, the search code “AG32 GD1 GP2 MS1” would effectively search for the 4 criteria above, yet only consume 1 criterion of the available 10 criteria. This search strategy will be call “search by sequence”.

Profile Sequence to Allow Search by Sequence

To take advantage of search by sequence, profile tags may be placed in defined sequences. Tags representing related characteristics of an entity are placed next to each other. In one embodiment, age, gender, gender preference, and marital status are grouped together, to create a profile sequence. For example, the code explained above, “AG32 GD1 GP2 MS 1”, is a profile sequence. Other profile sequences are explained below in the section entitled “Example of Identification Coding System for People.”

Combination Sequences to Allow Search by Sequence

To take advantage of search by sequence, all possible combinations of certain tags are generated. For example, the tag for a person who lives in the United States, California and who speaks Spanish, English and Chinese would be “CT133 ST123 LG01 LG02 LG03”. Using the search strategy of searching for a sequence, it is possible to search for only residents of California who speaks Spanish using the search code “ST123 LG01”. However, if every combination of the sequence (CT133 LG01, CT133 LG02, CT133 LG03, etc . . . ) is also included in the identification code, then it would be possible to search for a person living in California who speaks Chinese using only the search code “CT133 LG03”.

Including combination sequences allow certain tags to be omitted but still allow searching by sequence. For example, the sequence “GD1 GP2 MS1” can be used to search for a male whose gender preference is female and marital status is single. If a member decides to omit the gender preference tag, GP2, search by sequence can not be accomplished. However, by including combination sequences, including “GD1 MS1”, search by sequence is still possible even if the middle tag is omitted.

Range Sequences to Allow Range Search Using a Search Engine

Range tags may be used for range searches and, in one embodiment, may be encoded using 3 different coding methods (see below). A range sequence is made of all the range tags that describes a certain criteria range. It should equally be appreciated that this range coding may be applied to other demographic and trait categories such as income level, personality traits, height, etc. In addition, range coding may be used, but not limited to, time durations, dimensions, and other characteristics of other entities.

Range Sequence Type 1

In one embodiment, tags may be added together to represent ranges. For example, a person's physical attractiveness can be represented by the tag prefix “PA” and encoded as follows:
below average=“PA”
average=“PA PA”
above average=“PA PA PA”
very attractive=“PA PA PA PA”
model looks=“PA PA PA PA PA”

Using a search engine, if a user wants to search for everybody who is “at least” average and above, they could use the search code “PA PA” and the result would include all people have average, above average, very attractive, and model looks.

Range Sequence Type 2

Characters that represent “greater than” and “less than” may also be added to the tag. In one embodiment, “gt” may be used to represent “greater than,” while “It” may represent “less than”. For example, a person who is 33 may have this range sequence to represent age:
gtAG13 gtAG14 . . . gtAG32 ltAG34 ltAG35 . . . ltAG100

In one embodiment, this method requires the use of 2 keywords to search for a range in a search engine. Theoretically, every combination of gtAG and ItAG tags belonging to this range sequence could be used to create combination sequences that could be included in the identification code to allow the use of just 1 search engine criterion to search for a range.

Range Sequence Type 3

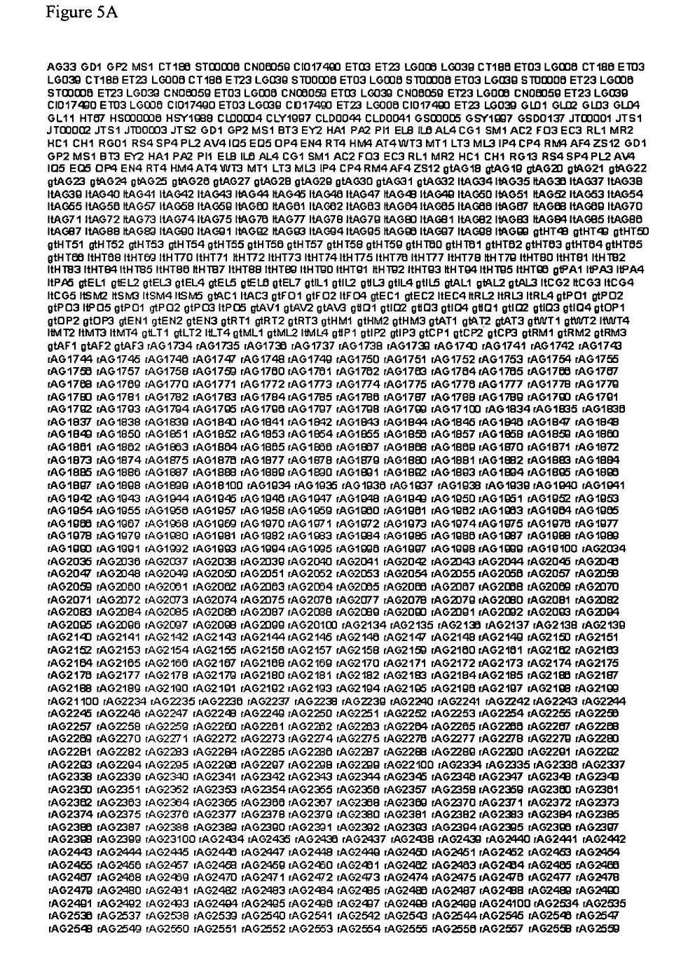

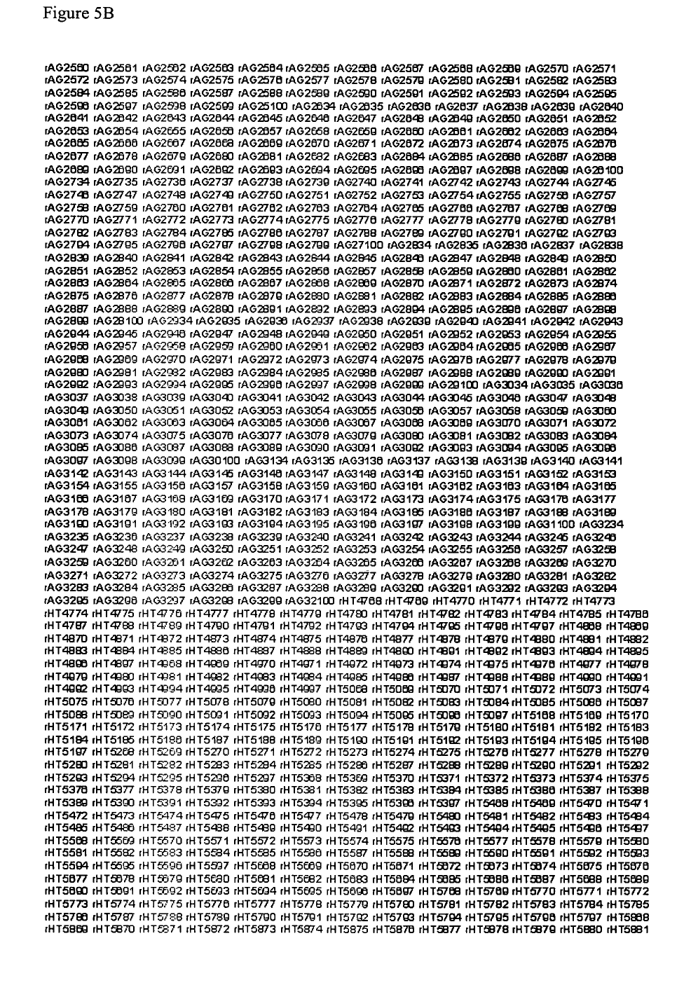

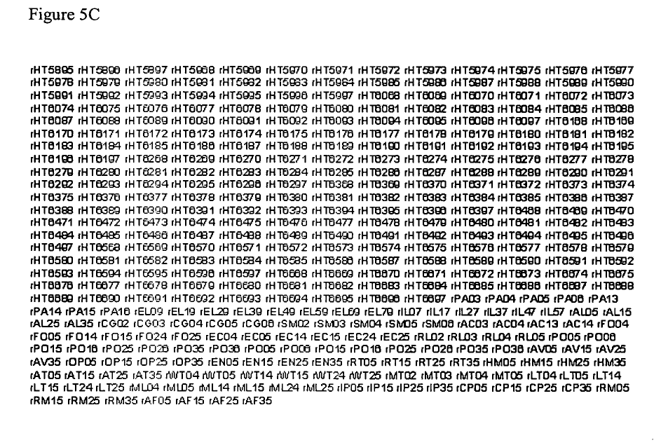

All combination of ranges are encoded. For example, an age of 33 can be encoded by creating all the possible combination of tags consisting of:
“r”+tag prefix+bottom age+upper age
   The bottom age will range from lowest number to (age−1) and the upper age will range from (age+1) to highest number. In this example, the bottom age will be 17 to 32 and the upper age will range from 34 to 100. In one embodiment, this method requires the use of 1 keyword to search for a range in an Internet search engine (see example of FIG. 5A-5C).

“Looking For” Tags

In one embodiment, “looking for” tags may be used to encode a member's search criteria if a member wishes to make their search criteria public. Any tag can be transformed into a “looking for” tag by adding an additional prefix to the tag. In one embodiment, the prefix, “lf”, may be added to the tag. A “looking for” sequence is a series of “looking for” tags that are arranged in order to allow for search by sequence. A man who is seeking all single white female may wish to include this type of sequence in his identification code. The profile sequence for single white women is “MS 1 ET24 GD2”. By transforming this sequence into the “looking for” profile sequence, “lfMS1 lfT24 lfGD2”, and including it into his identification code, members could search for him and all members who are seeking a single, white woman. Any tag, including range and combination types, can also be transformed into “looking for” tags.

Controlled Vocabulary Based on Code

The identification system is not based on keywords, but rather on codes. Identification systems based on keywords tend to be less robust because many keywords or phases can represent identical concepts. For example, “M.D.”, “MD”, “medical doctor”, “physician”, and “doctor” can all be used to identify a person with a medical doctorate degree. Therefore, in one embodiment a single tag (e.g., JT00344) can be used to encode multiple keyword forms. Moreover, because the code is not based on words, it may not interfere with other web pages, thus effectively separating tagged pages from other web pages in Internet search engine search results.

Code Based Identification System Allows Feasible Grid Computing

Because the identification system is based on codes, its use in grid computing is made feasible because the distributed files may be much smaller resulting in less bandwidth, download time, hard drive storage, memory usage, and search time. Note that combination of range tags or sequences are not included in the index that is searched by the grid search method.

Standardized Spelling of Text Descriptions to Allow Keyword Search

Corresponding text that the tag represents are also included on the web page to standardize and facilitate keyword searching using a search engine. In one embodiment, these text descriptions are standardized for all members' web pages. For example, search engine users may be able to search for actual text as well as using the identification system's tags. Currently, text descriptions are not standardized because certain descriptions could be spelled differently. Abbreviation, slang, different tenses, and plurality could be also used resulting in many possible spellings. Thus, members of the dedicated site (e.g., SocialGrid) may use a standardized database of words and abbreviations, as well as the identification system that all members have agreed to. For example, the movie “Lord of the Rings: The Return of the King”™ can be described in various ways:
LOTR™
The Return of the King™
LOTR: The Return of the King™
Lord of the Rings™

If members use the identification application to generate their web pages, all members whose favorite movie is “Lord of the Rings: The Return of the King”™ will have this text on their web page, not the other version listed above. To search for all members who love this epic movie who are single, a search engine user may simply the following search code in an Internet search engines:
+SocialGrid+MS1+“Lord of the Rings: The Return of the King”

Note that, in one embodiment, all members have the word “SocialGrid” included in their web pages (including title and meta tags as well as the body of the web page) to identify that they are members. This standardization of text descriptions may be done for all profile categories (demographic, traits, interests, etc.). The result of including text description is to allow searches for keywords to be used along with search code.

Identification Coding System of People

1. Guidelines

The identification code may be generated using, for example, the following guidelines:
a. The Symbol “#”

In one embodiment, the symbol “#” represents a serial number. Multiple #s represent multiple numbers. For some tags, serial numbers may be defined below the category. Others are defined by a long list that is stored in a database.

b. Multiple Tags

Some categories may allow multiply tags in the same category to be placed adjacent to each other separated by a space. For example, in the case of a member who knows three languages, instead of having just one language code tag “LG###”, this characteristic can be represented with multiple code tags, “LG### LG### LG###”. In one embodiment, all categories that allow multiple tags may have “multiple tags” underneath the category label.

c. Frequency Tag

In one embodiment, this type of tag encodes how often an activity, interest, or hobby occurs or is performed. A frequency tag may be constructed by adding a frequency number at the end of another tag, where each additional number corresponds to a different frequency. For example, to describe the frequency of occurrence of an interest, the frequency number may be one of:
1=daily
2=weekly
3=monthly
4=3 months
5=6 months
6=annually

Thus, a profile code could include the tag “IT2321” to represent a certain interest, say traveling (note that the code “2321” would be associated with traveling in this embodiment). In turn, IT23216 encodes that traveling occurs annually since the additional number 6 at the end of the original fragment corresponds to the frequency of annually. The frequency tag could either be attached to the tag or separated by a space, “IT2321 6”.

d. Status Tag

This type of tag may be used to encode whether a membership, enrollment, affiliation, or employment is current or past. In one embodiment, this status tag is a number. Adding an additional number to the end of a tag forms a status tag. For example, the number for membership in an interest organization could be:
1=current
2=past

Thus, a tag such as “IO123456” to represent membership into a certain organization can lengthen by adding a number 1 to the end to form IO1234561 encodes that this membership as current. The status tag could either be attached to the tag or separated by a space, “IO123456 1”.

2. Coding Examples

The identification code may be generated using, for example, the following coding conventions. It should be understood that any number of coding variations and conventions may similarly be used and the following represents a non-limiting example only.

a. General Information

In one embodiment, general information may be encoded in the following profile sequence order: AG## GD# GP# MS# CT### ST##### CN#### CI##I#### ET## LG### GL# where,
AG##=Age
GD#=Gender
   1=male
   2=female
   3=transgender male
   4=transgender female
   5=any
GP#=Gender Preference
   1=male
   2=female
   3=transgender male
   4=transgender female
   5=any
MS#=Marriage Status
   1=single
   2=in a relationship
   3=married
   4=separated
   5=divorced
   6=widowed
   7=open marriage
   8=any
Location
CT###=Country
ST#####=State/Province
CN####=County
CI######=City
ET##=Ethnicity
LG###=Language
   *multiple fragments allowed, database generated serial number
GL#=Goals
   1=make new friends
   2=find old friends
   3=dating
   4=career networking
   5=looking to hire
   6=looking for a job
   7=mentorship program
   8=activity buddy
   9=study group
   10=community service
   11=help others network
   12=any

b. Appearance

In one embodiment, appearance information may be encoded in the following profile sequence order: HT## BT# EY# HR# FA## BA##where,
HT##=Height
BT#=Body Type
   1=slender
   2=athletic
   3=average
   4=a few extra pound
   5=heavyset
   6=other
   7=any
EY#=Eyes
   1=black
   2=brown
   3=blue
   4=hazel
   5=gray
   6=green
   7=any
HR#=Hair
   1=black
   2=brown
   3=dark blonde
   4=blonde
   5=auburn/red
   6=salt and pepper
   7=gray
   8=other
   9=any
FA##=Facial Attractiveness
BA##=Body Attractiveness
PI=Have picture

c. Interests and Hobbies

In one embodiment, interest/hobby information may be encoded in the following profile sequence order: IT###### IO###### MA###### SG###### TV###### MV###### AU###### BK###### MG#### where,
IT######=Interest
IO######=Community Organizations
   *multiple fragments allowed, database generated serial number
   *able to form status fragment
MA######=Favorite Music Artists
   *multiple fragments allowed, database generated serial number
SG######=Favorite Songs
   *multiple fragments allowed, database generated serial number
TV######=Favorite Television Shows
   *multiple fragments allowed, database generated serial number
MV######=Favorite Movies
   *multiple fragments allowed, database generated serial number
AU######=Favorite Authors
   *multiple fragments allowed, database generated serial number
BK######=Favorite Books
   *multiple fragments allowed, database generated serial number
MG###### =Favorite Magazines/Newspaper
   *multiple fragments allowed, database generated serial number

d. Education

In one embodiment, education information may be encoded in the following profile sequence order: Sequence Order: EL###### HSY#### HSA### CL##### CLD#### CLY#### CLA### GS##### GSD#### GSY#### GSA### CF##### where,
EL#=Education Level
   1=Junior High School
   2=High School
   3=Some College
   4=Junior College
   5=Technical Certification
   6=Bachelor's Degree
   7=Master's Degree

8=Doctorate

High School

| | |
|---|---|
| HS###### = School | |
| Graduation/End Year | HSY#### |
| Activities/Clubs | HSA### |

*able to form status fragment

College

| | |
|---|---|
| School | CL##### |
| Degree | CLD#### |
| Graduation/End Year | CLY#### |
| Activities/Clubs | CLA### |

*able to form status fragment

Graduate/Professional
GS#####=School
GSD####=Degree
GSY####=Graduation/End Year
GSA###=Activities/Clubs
   *able to form status fragment
CF#####=Certifications, Licenses, etc.

e. Career

In one embodiment, career information may be encoded in the following profile sequence order: JI### JT##### J##### IL# AL## CG#

Career Experience
JI###=Job Industry
JT#####=Job Title
   *able to form status fragment
JO#####=Career Organization
   *able to form status fragment
IL#=Income Level
   1=Less than $20,000
   2=$20,001-$40,000
   3=$40,001-$60,000
   4=$60,001-$80,000
   5=$80,001-$100,000
   6=$100,001-$120,000
   7=$120,001-$140,000

8=more than $150,000

| | |
|---|---|
| Ambition Levels | AL## |

*see trait code explanation

| | |
|---|---|
| Career Goals | CG# |

1=I am still searching for a career
2=I am working on a career
3=I work to just pay the bills
4=I enjoy my career
5=I love my career

f. Lifestyle

In one embodiment, lifestyle information may be encoded in the following profile sequence order: SM# AC# FO# EC# where,
SM#=Smoking
   1=never
   2=socially
   3=daily
   4=trying to quit
   5=chewable tobacco
AC#=Alcohol
   1=never
   2=socially
   3=regularly
FO#=Food
   1=strict vegetarian
   2=vegetarian including diary products
   3=healthy
   4=everything
EC#=Exercise
   1=never
   2=daily
   3=every other day
   4=weekly

g. Relationship

In one embodiment, relationship information may be encoded in the following profile sequence order: RL# MR# HC# CH#
RL#=Relationship
   1=Never been in love
   2=Been in love a few times
   3=Been in love several times
MR#=Marriage
   1=I am already married
   2=I am open to marriage
   3=I do not believe marriage
HC#=Have Children
   1=Do not have any
   2=Have children who live with me
   3=Have children who sometimes live with me
   4=Have children who do not live with me
CH#=Children
   1=Planning to have
   2=Planning to have more
   3=Do not plan to have

g. Religion and Politics

In one embodiment, religion and politics-related information may be encoded in the following profile sequence order: RG## SP## PO# AV##
RG##=Religion
   01=Catholic
   02=Protestant
   03=Mormon
   04=Other Christian
   05=Buddhist/Taoist
   06=Jewish
   07=Hindu
   08=Muslim
   09=Atheist
   10=Agnostic, Spiritual, Other
SP##=Spiritualism
   *see trait code explanation
PO#=Politics
   1=ultra conservative
   2=conservative
   3=moderate
   4=liberal
   5=very liberal
   6=radical
   7=other
AV##=Activism
   *see trait code explanation

h. Traits

In one embodiment, trait information may be encoded in the following profile sequence order: IQ## EQ## OP## EN## RT## HM## AT## WT## MT## LT## CP## RM##where,
can be:
   99=top 100 percentile
   95=top 95 percentile
   . . . decreasing by a multiple of 5 to
   05=top 5 percentile
   01=top 1 percentile
IQ##=Intelligence
EQ##=Emotional Intelligence
OP##=Optimism
EN##=Energy
RT##=Risk Tolerance
HM##=Humor
AT##=Artistic Talent
WT##=Writing Talent
MT##=Musical Talent
LT##=Language Talent
CP##=Compassion
RM##=Romantic

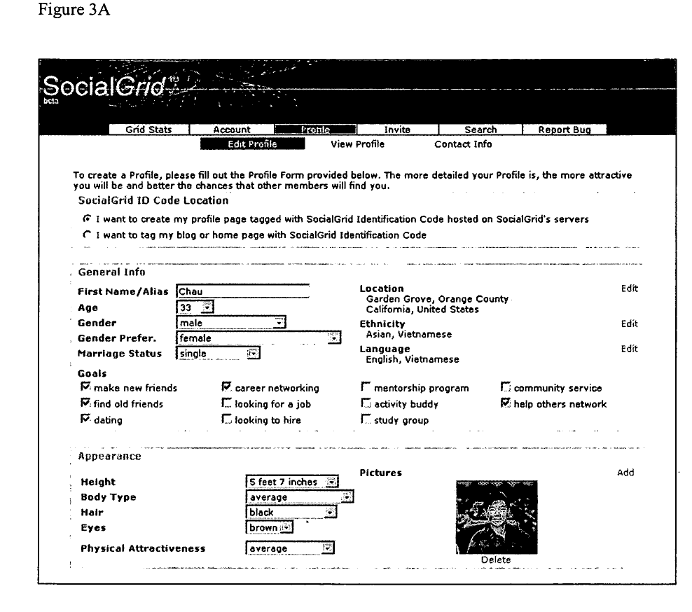

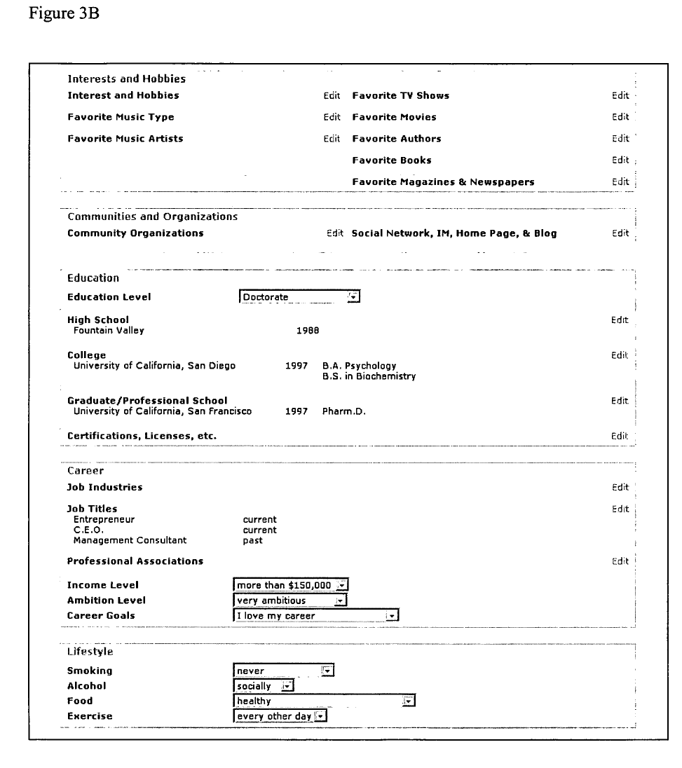

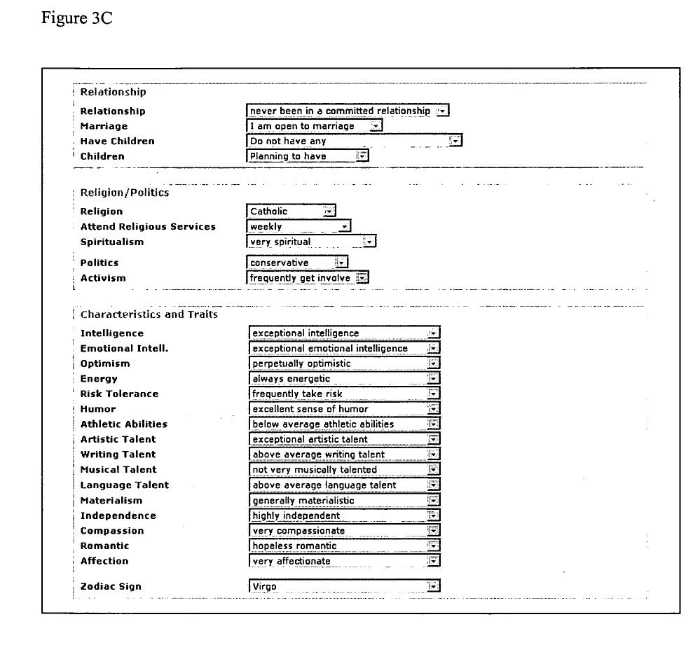

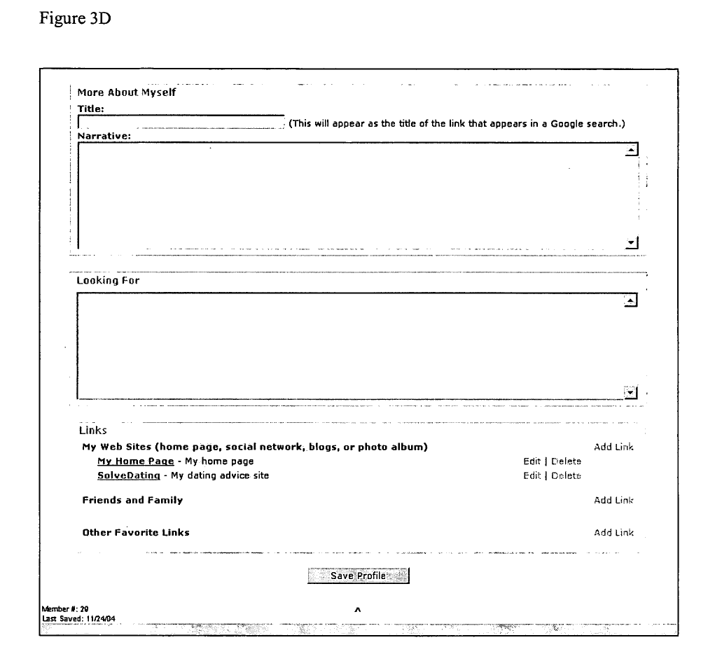

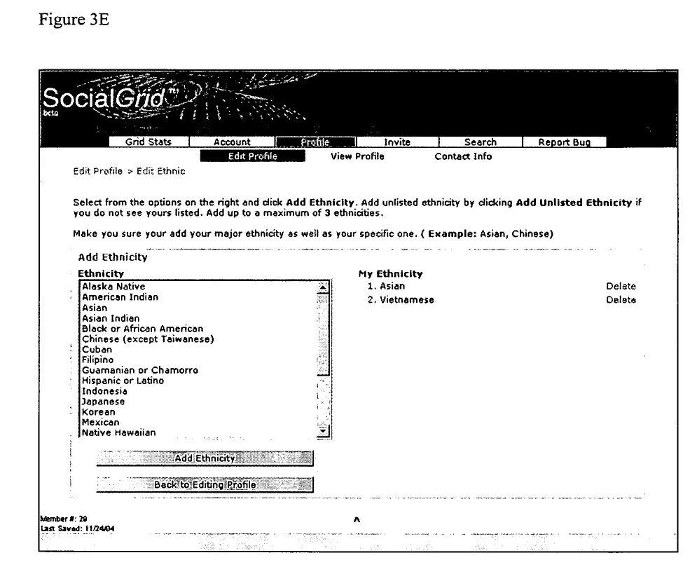

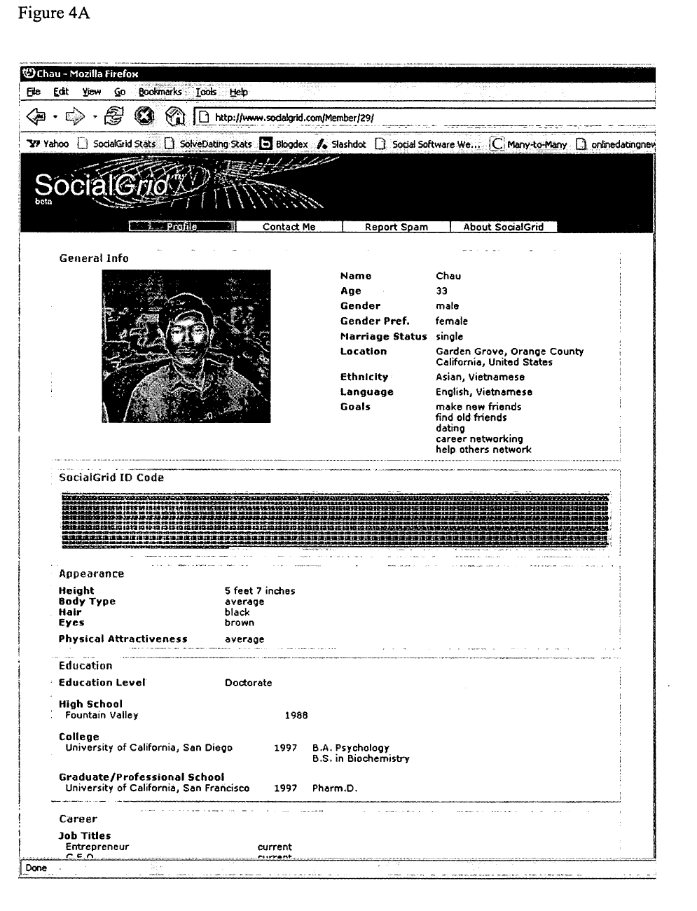

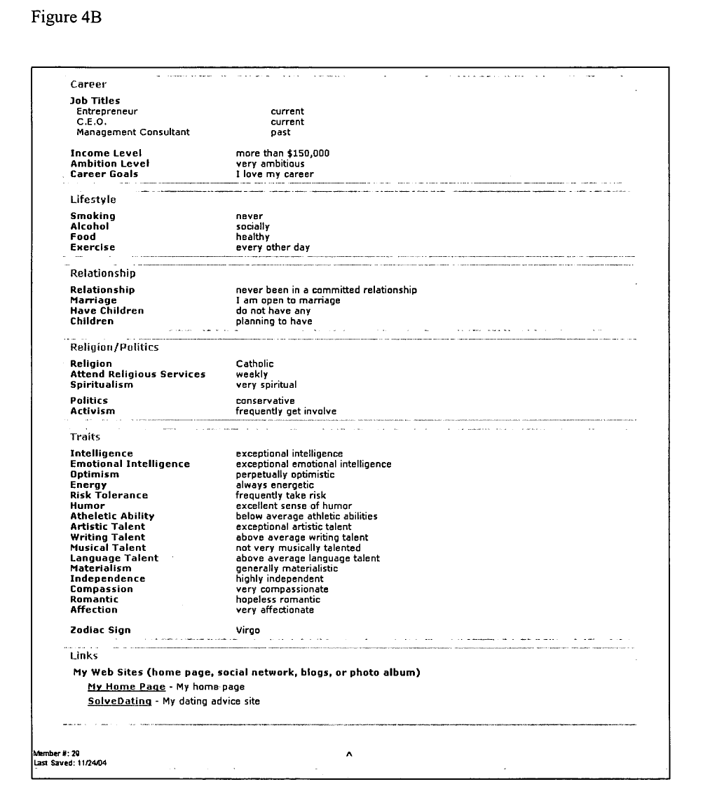

Various embodiments of how the above codes (or other embodiments of the above codes) may be implemented are shown in the attached figures. More particularly, FIGS. 3A-3E illustrate embodiments of graphical user interfaces for entering a user's identification information. The user may enter various forms of identification information using an online interface. Once entered, this information may then be reviewed on a presentation screen, such as that shown in FIGS. 4A-4B.

In one embodiment, the identification information entered may be converted by a process of the invention into identification code. FIG. 5A-5C illustrates one embodiment of an identification code corresponding to personal information entered by a user, for example, using the interfaces of FIGS. 3A-3E.

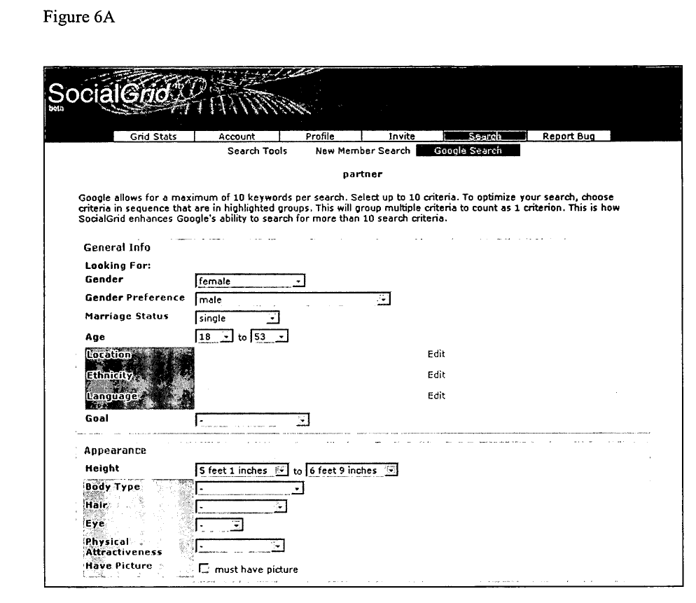

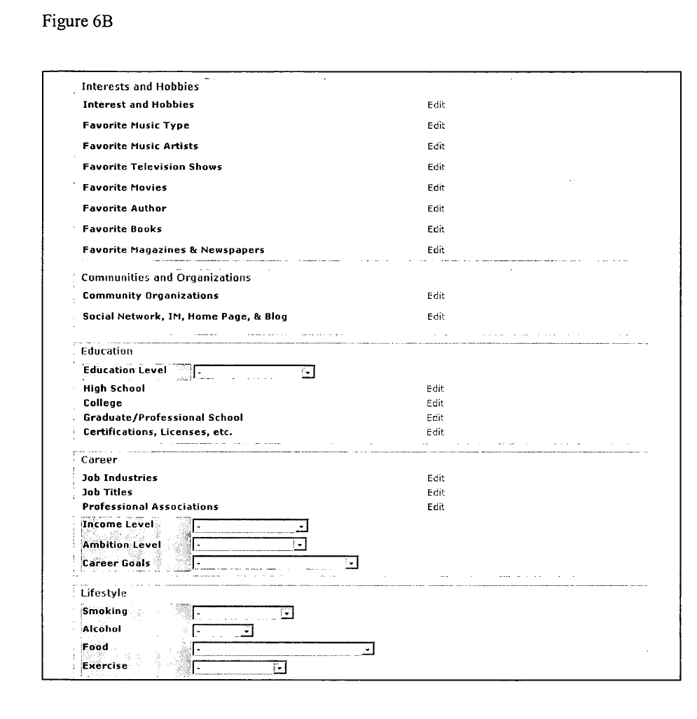

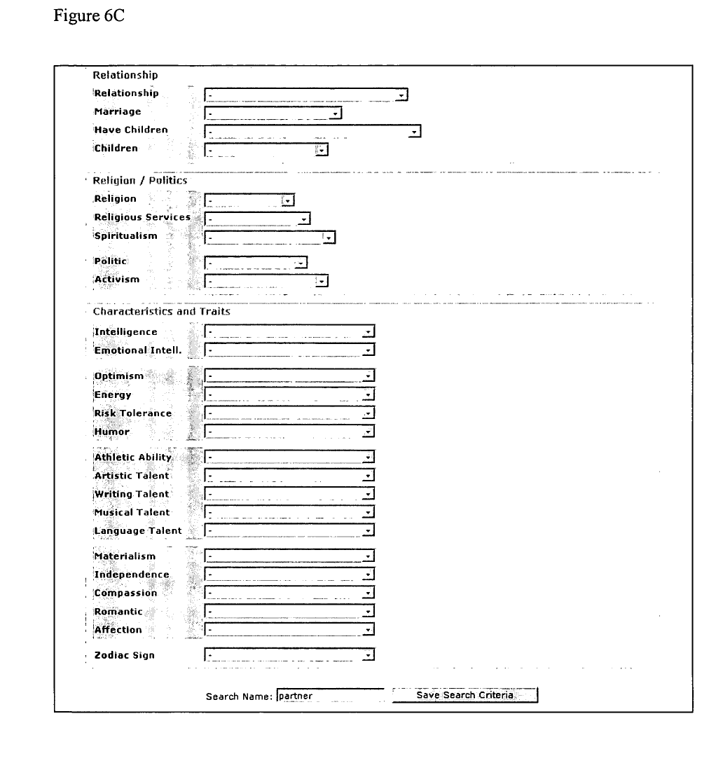

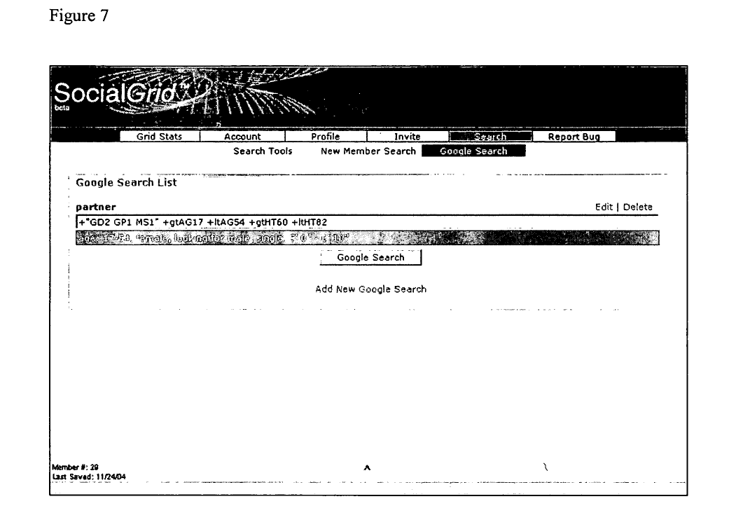

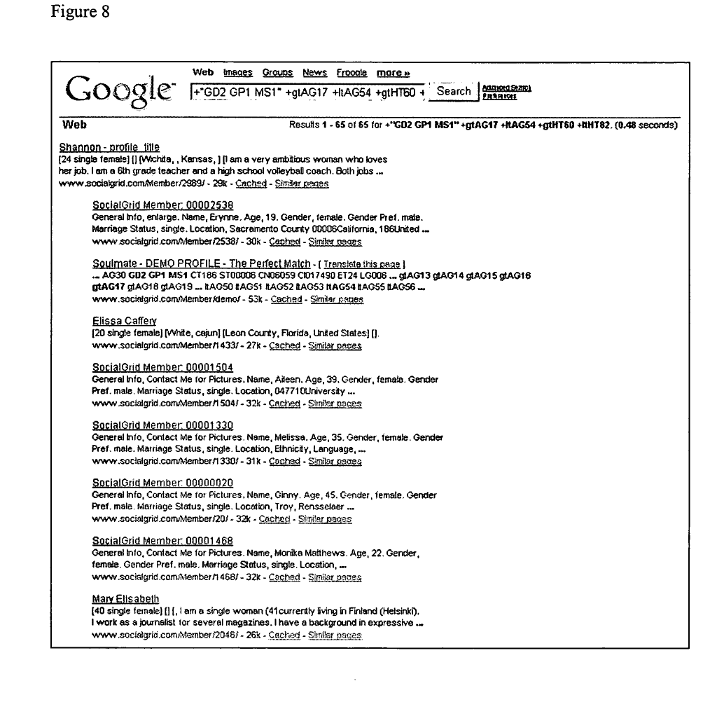

Once the identification information is entered and processed, the person (who has been identified) may participate in a search. For example, he or she may now be placed in a pool of participants who may be searched or located using the SocialGrid grid search application. FIG. 6A-6C illustrates examples of search tools available to a user in accordance with one aspect of the invention. FIGS. 6A-6C illustrate one embodiment of an interface for entering search criteria information for conducting a search. Thus, other people who wish to locate friends, employees, etc. may use the interface shown in FIGS. 6A-6C to assist them with their search. FIGS. 7, 8 illustrate an interface showing an example of the search code for a specified search.

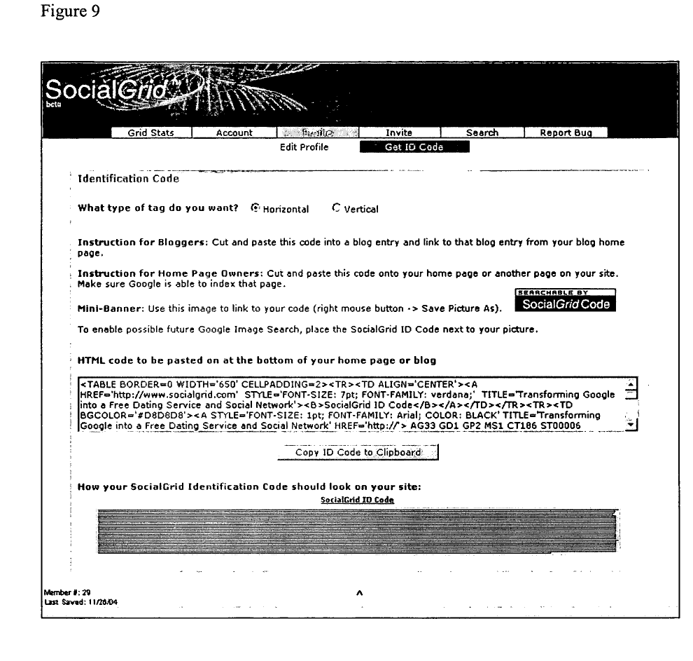

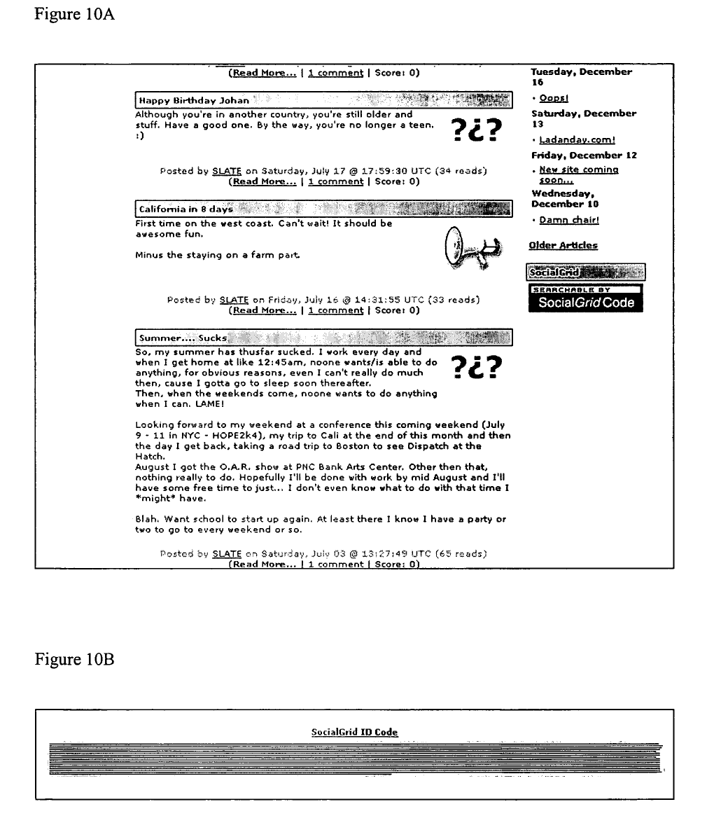

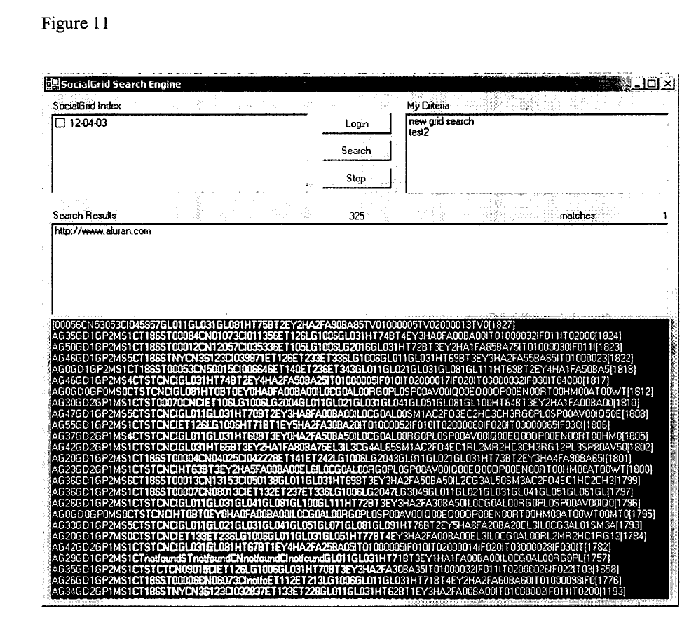

FIG. 9 illustrate examples of HTML code that may be pasted on the user's home page. The HTML code is based on the identification information provided. FIGS. 4A, 10A-10B also illustrate how the processed identification code may appear on the user's site, according to one embodiment. FIG. 11 illustrates one embodiment of a screen display of a search process using the SocialGrid grid search application. In this embodiment, the grid search application may search through the identification index to locate one or more targets or matches.

Identifying and Searching for Other Entities

Besides identifying and searching for people, the principles of the invention may be used to identify and search for other entities. By way of example, the invention is equally applicable to the following entities:
Groups (companies, organizations, association, partnerships, couples, or clubs)
Job opportunities, job locations, and job skills
Real estate, physical and geographical locations, including addresses
Web sites or virtual communities (message boards, chat rooms, online auctions, etc.)
Financial statements
Company assets such as equipment and intellectual property
Investment portfolio allocation, investment opportunities, investment vehicles and products, business opportunities
Products and services, including e-commerce and brick-and-mortar businesses, devices, systems, hardware, software, firmware, etc
Markets and auction systems (bids, asking price, offering price, etc.)
Events
Animals and plants
Relationships and social networks
Telephone numbers or IP addresses
Fictional characters, including characters from movies, television, books, and video games
Books, documents, contents, data, database records, and computer files
Transportation vehicles, including cars, boats, and airplanes
Biological, chemical and/or synthetic elements, molecules, structures and/or compounds, including drugs, pharmaceuticals, genes, biochemical and/or chemical pathways and processes, industrial elements, etc.
Audio, pictures, and video
   Other Applications Using Identification and Search System

Enhancing Advertisement Targeting

The identification code contains information that may be useful in targeting advertisements. In one embodiment, identification code can be sent to an advertisement network to determine what advertisements should be displayed on web pages and web sites that the identification code identifies or is located, respectively. In another embodiment, search code or search criteria of an identification code can be sent to an advertisement network to determine what advertisements should be displayed on search result pages. For example, a search code to find a plastic surgeon in a certain city can be sent to an advertisement server to display advertisements of competing, local plastic surgeons next to the search results.

Privacy Access Filter

Each profile category can be assigned a privacy level. In one embodiment, the possible privacy levels are:
1. Public
2. Friends—only those who links to you can see this category
3. Friend of a Friend
4. Privacy—only those you add to your privacy list can view this category

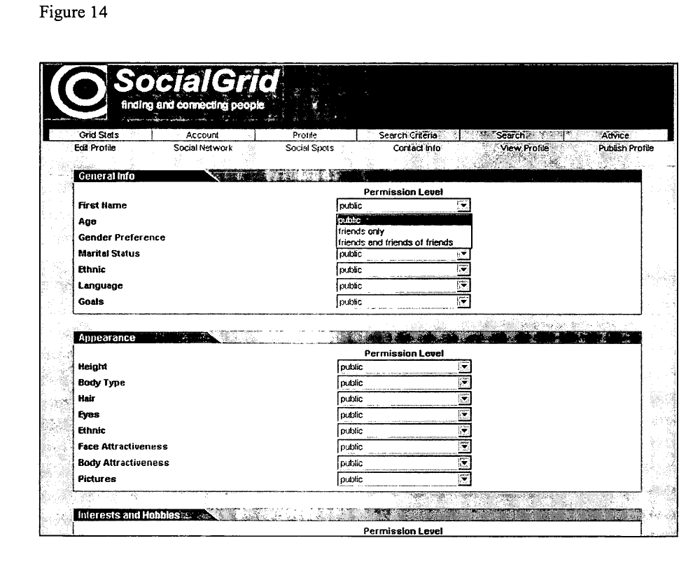

FIG. 14 illustrates one embodiment of an interface for implementing a Privacy Access Filter.

Contact Filter Service

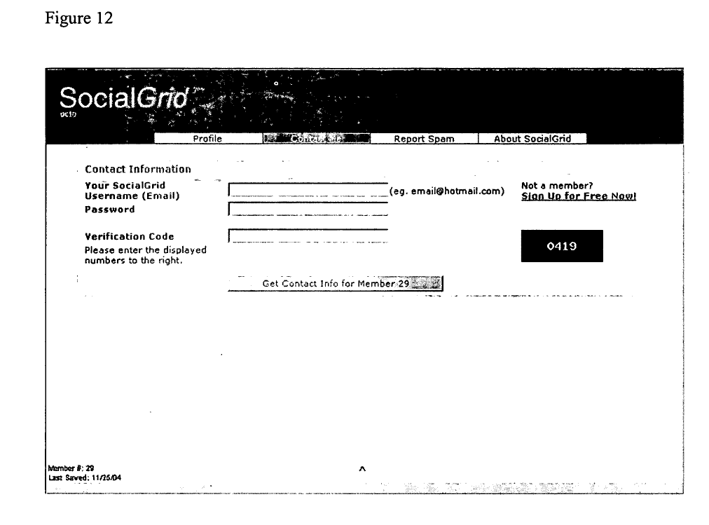

Because members' profiles are exposed to the whole world, all members' contact information may be guarded against e-mail harvesting bots and spiders by requiring the contact initiator to input a randomized series of alphanumeric characters displayed on a screen. FIG. 12 illustrates one embodiment of an interface for initiating contact with a target or a member.

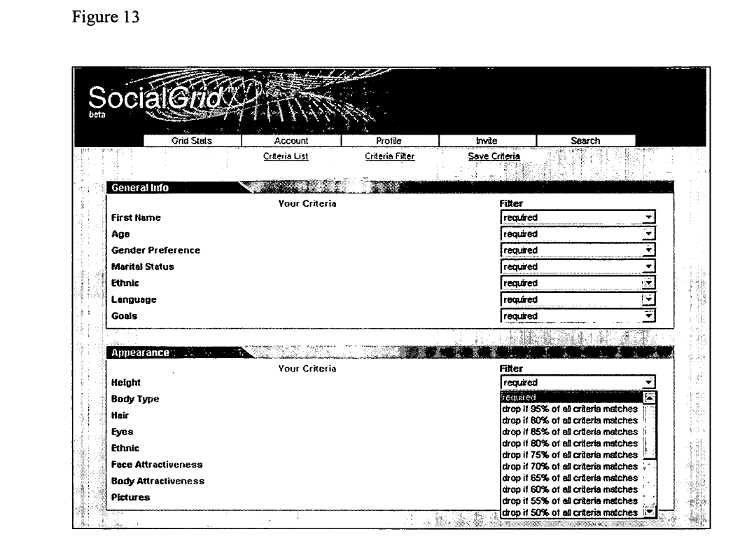

Very attractive members may receive many requests to be contacted. As such, members desiring to filter contact requests may do so by specifying which criteria must match, and which ones may be dropped (i.e., do not have to match). FIG. 13 illustrates one embodiment of an interface for implementing contact criteria to be used in filtering content requests. When a contact initiator wishes to contact a member with a filter, the initiator's own identification code will be retrieved from the membership database and compared to the member's contact criteria to see if it is able to pass the criteria filters.

If it does, then the member's contact information is revealed to the initiator. If not, a message may be provided to the contact initiator indicating that their request has been filtered out. This contact filter may also be used for compatible matching that will recommend matches to members.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

1. A method comprising:
receiving identification information representative of a plurality of characteristics of an entity;
representing said identification information with an identification code, wherein said identification code is comprised of a plurality of tags; and
incorporating said identification code into a digital file associated with said entity, wherein said digital file can be located using a search code containing at least a portion of said identification code.

2. The method of claim 1, wherein said plurality of tags are arranged in a predetermined order.

3. The method of claim 1, wherein said digital file is a webpage which can be located using the search code provided to an Internet search engine.

4. The method of claim 1, wherein each of said plurality of tags corresponds to one of said plurality of characteristics.

5. The method of claim 1, wherein said entity is an individual and said plurality of characteristics includes at least one of age, gender, gender preference, marital status, location, ethnicity, language, height, body type, eye color, hair color, facial attractiveness, body attractiveness, physical attractiveness, have picture, interests, community organizations, virtual communities, favorite music, favorite movies, favorite authors, favorite books/periodicals, education level, schools, job industry, job title, professional organizations, certification/licenses, income level, previous and current relationships, marriage goals, have children, children living with, religion, religious service attendance, political affiliation, activism and personality traits.

6. The method of claim 1, wherein said digital file is a webpage and said plurality of characteristics includes at least 11 separate characteristics of said entity.

7. The method of claim 1, wherein said entity is one of a person, corporate structure, a job-related listing, real estate listing, virtual community, website, financial statement, investment-related listing, a portfolio allocation, a product, a service, a market, an auction, an event, a plant, an animal, a social network, a fictional character, a book, a document, data, a data record, a digital file, a multimedia product, a vehicle, a biological structure/process and a chemical structure/process.

8. The method of claim 1, further comprising indexing identification codes for a plurality of entities to form an entity index.

9. The method of claim 8, wherein indexing said identification codes comprises harvesting identification codes using an Internet-based search application.

10. The method of claim 8, wherein said entity index is maintained on one or more servers and is searchable by said plurality of entities.

11. The method of claim 8, wherein said entity index is maintained on one or more electronic devices and is searchable by said plurality of entities.

12. The method of claim 8, further comprising searching said entity index, using at least the portion of said identification code, for said entity.

13. The method of claim 1, wherein said plurality of tags includes a profile tag, a combination tag and a range tag, wherein said profile and combination tags correspond to at least one of said plurality of characteristics for said entity, and said range tag is comprised of a characteristic range which includes at least one of said plurality of characteristics to which said range tag corresponds.

14. The method of claim 1, wherein said identification code further comprises a profile sequence, a combination sequence and a range sequence, wherein said profile and combination sequences correspond to at least one of said plurality of characteristics for said entity, and said range sequence is comprised of a characteristic range which includes at least one of said plurality of characteristics to which said range sequence corresponds.

15. The method of claim 1, wherein said identification code further comprises a looking-for profile sequence, a looking-for combination sequence and a looking-for range sequence, wherein said looking-for profile sequence and looking-for combination sequence corresponds to a desired entity characteristic and said looking-for range sequence corresponds to a desired entity characteristic range.

16. The method of claim 15, wherein said looking-for sequence, looking-for combination sequence and looking-for range sequence are tags and included in said plurality of tags.

17. The method of claim 1, wherein said digital file is a webpage and incorporating comprises encoding said identification code into said webpage using hypertext markup language.

18. The method of claim 1, wherein said digital file is a digital stream and incorporating comprises encoding said identification code into said digital stream.

19. The method of claim 1, wherein said digital file is a data record of a database application that can be located using a query statement entered into said database application.

20. The method of claim 1, wherein said digital file is a webpage and said incorporating comprises encoding said identification code in a hidden location of said webpage.

21. The method of claim 1, wherein representing comprises translating said identification information into said identification code according to a predetermined protocol.

22. The method of claim 1, wherein said identification code is a single sequence of characters which are representative of said identification information.

23. The method of claim 1, wherein receiving said identification information comprises:
entering said identification information into a user's electronic device using a user interface; and
transmitting said identification information to a remote server coupled to said user's electronic device via a network.

24. The method of claim 23, wherein said user's electronic device is one of a personal computer, a personal digital assistance and a cellular telephone.

25. The method of claim 23, wherein said network is one of a wireless network, a local area network, Internet, peer-to-peer file sharing network, grid computing network and a media network.

26. The method of claim 1, wherein said incorporating said identification code comprises incorporating said identification code into one of a printed label, RFID tag, smart card, cellular telephone and personal digital assistance.

27. The method of claim 1, further comprising:
matching at least one advertisement profile to said identification code; and
displaying an advertisement based on said matching.

28. The method of claim 1, further comprising:
matching at least one advertisement profile to said search code; and
displaying an advertisement based on said matching.

29. The method of claim 1, further comprising:
matching at least one search code to said identification code; and
displaying contact information based on said matching.

30. The method of claim 1, further comprising:
matching at least one identification code to said search code; and
displaying contact information based on said matching.

31. The method of claim 30, wherein said search code is search criteria usable by an Internet-based search application to search said identification codes.

32. The method of claim 1, further comprising:
representing said plurality of characteristics with a search code;
performing a search using a software application, wherein said search code is based on at least a portion of said identification code of the desired entity; and
representing said plurality of characteristics with variables of a computer programming language;
performing a search using a software application, where said variables match at least a portion of said identification code of the desired entity; and
locating the digital file associated with said desired entity from said search.

33. The method of claim 32, wherein said software application is a grid application residing on an electronic device.

34. The method of claim 32, wherein said software application uses conditionals, comparative and logical operators of said computer programming language to determine if at least a portion of the said identification code matches the said variables

35. A system comprising:
a network;
a user electronic device coupled to said network; and
a server coupled to said user electronic device via said network, wherein said server is to,
receive identification information representative of a plurality of characteristics of an entity,
represent said identification information with a identification code, wherein said identification code is comprised of a plurality of tags, and
incorporate said identification code into a digital file associated with said entity, wherein said digital file can be located using a search code containing at least a portion of said identification code.

36. The system of claim 35, wherein said plurality of tags are arranged in a predetermined order.

37. The system of claim 35, wherein said digital file is a webpage which can be located using the search code provided to an Internet search engine.

38. The system of claim 35, wherein each of said plurality of tags corresponds to one of said plurality of characteristics.

39. The system of claim 35, wherein said entity is an individual and said plurality of characteristics includes at least one of age, gender, gender preference, marital status, location, ethnicity, language, height, body type, eye color, hair color, facial attractiveness, body attractiveness, physical attractiveness, have picture, interests, community organizations, virtual communities, favorite music, favorite movies, favorite authors, favorite books/periodicals, education level, schools, job industry, job title, professional organizations, certification/licenses, income level, previous and current relationships, marriage goals, have children, children living with, religion, religious service attendance, political affiliation, activism and personality traits.

40. The system of claim 35, wherein said digital file is a webpage and said plurality of characteristics includes at least 11 separate characteristics of said entity.

41. The system of claim 35, wherein said entity is one of a person, corporate structure, a job-related listing, real estate listing, virtual community, website, financial statement, investment-related listing, a portfolio allocation, a product, a service, a market, an auction, an event, a plant, an animal, a social network, a fictional character, a book, a document, data, a data record, a digital file, a multimedia product, a vehicle, a biological structure/process and a chemical structure/process.

42. The system of claim 35, wherein said server is further to index identification codes for a plurality of entities to form an entity index.

43. The system of claim 42, wherein said entity index is maintained on one or more servers and is searchable by said plurality of entities.

44. The system of claim 42, wherein said server is further to search said entity index, using at least the portion of said identification code, for said entity.

45. The system of claim 42, wherein said entity index is based on an Internet-based search application harvesting said identification codes.

46. The system of claim 42, wherein said entity index is maintained on one or more electronic devices and is searchable by said plurality of entities.

47. The system of claim 35, wherein said identification code further comprises a profile sequence, a combination sequence and a range sequence, wherein said profile and combination sequence correspond to at least one of said plurality of characteristics for said entity, and said range sequence is comprised of a characteristic range which includes at least one of said plurality of characteristics to which said range sequence corresponds.

48. The method of claim 35, wherein said plurality of tags includes a profile tag, a combination tag and a range tag, wherein said profile and combination tags correspond to at least one of said plurality of characteristics for said entity, and said range tag is comprised of a characteristic range which includes at least one of said plurality of characteristics to which said range tag corresponds.

49. The system of claim 35, wherein said plurality of tags further includes a looking-for profile sequence, a looking-for combination sequence and looking-for range sequence, wherein said looking-for profile sequence and looking-for combination sequence correspond to a desired entity characteristic, and said looking-for range sequence corresponds to a desired entity characteristic range.

50. The system of claim 35, wherein said digital file is a webpage and said incorporating comprises encoding said identification code into said webpage using hypertext markup language.

51. The system of claim 35, wherein said digital file is a webpage and said incorporating comprises encoding said identification code in a hidden part of said webpage.

52. The system of claim 35, wherein said digital file is a data record of a database application that can be located using a query statement entered into said database application.

53. The system of claim 35, wherein said server to represent said identification information translates said identification information into said identification code according to a predetermined protocol.

54. The system of claim 35, wherein said identification code is a single sequence of characters which are representative of said identification information.

55. The system of claim 35, wherein said identification information is to be entered into said user electronic device using a user interface, and transmitted to said server via said network.

56. The system of claim 55, wherein said user electronic device is one of a personal computer, a personal digital assistance and a cellular telephone.

57. The system of claim 55, wherein said network is one of a wireless network, a local area network, Internet, peer-to-peer file sharing network, grid computing network and a media network.

58. The system of claim 35, wherein said server to incorporate said identification code, incorporates said identification code into one of a printed label, RFID tag, smart card, cellular telephone and personal digital assistance.

59. The system of claim 35, wherein at least one of said server and user electronic device are further to:
match at least one advertisement profile to said identification code; and
display an advertisement on said user electronic device based on said matching.

60. The system of claim 35, wherein at least one of said server and user electronic device are further to:
transmit said search code to an advertisement server, wherein said advertisement server includes one more advertisement profiles;
match at least one of said advertisement profiles to said search code; and
display an advertisement on said user electronic device based on said matching.

61. The system of claim 35, wherein at least one of said server and user electronic device are further to:
transmit said identification code to a remote server, wherein said remote server includes one more search codes of other entities;
match at least one of said search codes to said identification code; and
display contact information to said entity based on said matching.

62. The system of claim 35, wherein at least one of said server and user electronic device are further to:
transmit said search code to a remote server, wherein said remote server includes one more identification code of other entities;
match at least one of said identification code to said search code; and
display contact information to said entity based on said matching.

63. The system of claim 62, wherein said search code is search criteria usable by an Internet-based search application to search said identification codes.

64. A method comprising:
entering, using a user interface, identification information representative of a plurality of characteristics of an entity;
translating said identification information into an identification code, wherein said identification code is comprised of a plurality of tags;
incorporating said identification code into a digital file associated with said entity.

65. The method of claim 64, wherein said plurality of tags are arranged in a predetermined order.

66. The method of claim 64, wherein said digital file is a webpage which can be located using the search code entered into an Internet search engine.

67. The method of claim 64, wherein each of said plurality of tags corresponds to one of said plurality of characteristics.

68. The method of claim 64, wherein said digital file is a webpage and said plurality of characteristics includes at least 11 separate characteristics of said entity.

69. The method of claim 64, further comprising indexing identification codes for a plurality of entities to form an entity index.

70. The method of claim 69, wherein said entity index is maintained on one or more servers searchable by at least some of said plurality of entities.

71. The method of claim 69, wherein said entity index is maintained on one or more electronic devices and is searchable by said plurality of entities.

72. The method of claim 69, wherein indexing said identification codes comprises harvesting identification codes using an Internet-based search application.

73. The method of claim 64, wherein said identification code is further comprised of a profile sequence, a combination sequence and a range sequence, wherein said profile and combination sequences correspond to at least one of said plurality of characteristics for said entity, and said range sequence is comprised of a characteristic range which includes at least one of said plurality of characteristics to which said range sequence corresponds.

74. The method of claim 64, wherein said plurality of tags includes a profile tag, a combination tag and a range tag, wherein said profile and combination tags correspond to at least one of said plurality of characteristics for said entity, and said range tag is comprised of a characteristic range which includes at least one of said plurality of characteristics to which said range tag corresponds.

75. The method of claim 64, wherein said identification code further includes a looking-for profile sequence, looking-for combination sequence and a looking-for range sequence, wherein said looking-for profile sequence and looking-for combination sequence correspond to a desired entity characteristic, and said looking-for range sequence corresponds to a desired entity characteristic range.

76. The method of claim 75, wherein said looking-for profile sequence, looking-for combination sequence and looking-for range sequence are tags and included in said plurality of tags.

77. The method of claim 64, wherein said digital file is a digital stream and incorporating comprises encoding said identification code into said digital stream.

78. The method of claim 64, wherein said digital file is a webpage and the method further comprises searching for said webpage using a search code containing at least a portion of said identification code provided to a search engine.

79. The method of claim 64, wherein said digital file is a webpage and said incorporating comprises encoding said identification code into said webpage using hypertext markup language.

80. The method of claim 64, wherein said digital file is a webpage and said incorporating comprises encoding said identification code in a hidden part of said webpage.

81. The method of claim 64, wherein said digital file is a data record of a database application that can be located using a query statement entered into said database application

82. The method of claim 64, further comprising:
matching at least one advertisement profile to said identification code; and
displaying an advertisement based on said matching.

83. The method of claim 64, further comprising:
matching at least one advertisement profiles to said search code; and
displaying an advertisement based on said matching.

84. The method of claim 83, wherein said search code is search criteria usable by an Internet-based search application to search said identification codes.

85. The method of claim 84, wherein said search criteria is represented with computer programming language variables.

86. The method of claim 85, wherein said matching uses conditionals, comparative and logical operators of a computer programming language to determine if at least a portion of the said advertisement profiles matches the said variables.

87. A method of locating a desired entity comprising:
identifying a plurality of characteristics of the desired entity;
representing said plurality of characteristics with a search code, wherein said search code is comprised of a plurality of tags;
performing a search using a search engine, wherein said search is based on at least a portion of said search code; and
locating a digital file associated with said desired entity from said search.

88. The method of claim 87, wherein said plurality of tags are arranged in a predetermined order.

89. The method of claim 87, wherein said digital file is a webpage and said search engine is an Internet search engine.

90. The method of claim 87, wherein each of said plurality of tags corresponds to one of said plurality of characteristics.

91. The method of claim 87, wherein said entity is an individual and said plurality of characteristics includes at least one of age, gender, gender preference, marital status, location, ethnicity, language, height, body type, eye color, hair color, facial attractiveness, body attractiveness, physical attractiveness, have picture, interests, community organizations, virtual communities, favorite music, favorite movies, favorite authors, favorite books/periodicals, education level, schools, job industry, job title, professional organizations, certification/licenses, income level, previous and current relationships, marriage goals, have children, children living with, religion, religious service attendance, political affiliation, activism, and personality traits, and ranges thereof.

92. The method of claim 87, wherein said digital file is a webpage and said plurality of characteristics includes at least 11 separate characteristics of said desired entity.

93. The method of claim 87, wherein said entity is one of a person, corporate structure, a job-related listing, real estate listing, virtual community, website, financial statement, investment-related listing, a portfolio allocation, a product, a service, a market, an auction, an event, a plant, an animal, a social network, a fictional character, a book, a document, data, a data record, a digital file, a multimedia product, a vehicle, a biological structure/process and a chemical structure/process.

94. The method of claim 87, wherein said search code further comprises a profile sequence, combination sequence, and a range sequence, wherein said profile sequence and combination sequence corresponds to at least one of said plurality of characteristics for said desired entity, and said range sequence are comprised of a characteristic range which includes at least one of said plurality of characteristics to which said range sequence corresponds.

95. The method of claim 87, wherein said search code further comprises a profile tag, combination tag, and a range tag, wherein said profile tag and combination tag corresponds to at least one of said plurality of characteristics for said desired entity, and said range tag are comprised of a characteristic range which includes at least one of said plurality of characteristics to which said range tag corresponds.

96. The method of claim 87, wherein said search code further comprises a looking-for profile sequence, looking-for combination sequence and looking-for range sequence, wherein said looking-for profile sequence and looking-for combination sequence correspond to a desired entity characteristic and said looking-for range sequence corresponds to a desired entity characteristic range.

97. The method of claim 87, wherein said search code further comprises a looking-for profile tag, looking-for combination tag and looking-for range tag, wherein said looking-for profile tag and looking-for combination tag correspond to a desired entity characteristic and said looking-for range tag corresponds to a desired entity characteristic range.

98. The method of claim 87, wherein said digital file is a webpage and said profile code is encoded into said webpage using hypertext markup language.

99. The method of claim 87, wherein said digital file is a webpage and said profile code is encoded into a hidden part of said webpage.

100. The method of claim 87, wherein representing comprises translating said plurality of characteristics into said search code according to a predetermined protocol.

101. The method of claim 87, wherein said search code is a single sequence of characters which are representative of said plurality of characteristics.
